(19) United States
(12) Patent Application Publication
(10) Pub. No.: US 2014/0069007 A1
(43) Pub. Date: Mar. 13, 2014

(54) PLANT GROWTH FACILITATING APPARATUS PLANT GROWTH FACILITATING APPARATUS

(71) Applicants: SHIH-CHANG CHEN, HSINCHU COUNTY (TW); CHUN-LUNG CHIU, HSINCHU COUNTY (TW); YUAN-PENG LEE, MIAOLI COUNTY (TW); PO-HUNG LAI, MIAOLI COUNTY (TW); YI-ZHENG LU, MIAOLI COUNTY (TW)

(72) Inventors: SHIH-CHANG CHEN, HSINCHU COUNTY (TW); CHUN-LUNG CHIU, HSINCHU COUNTY (TW); YUAN-PENG LEE, MIAOLI COUNTY (TW); PO-HUNG LAI, MIAOLI COUNTY (TW); YI-ZHENG LU, MIAOLI COUNTY (TW)

(73) Assignee: CASHIDO CORPORATION, Miaoli County (TW)

(21) Appl. No.: 13/613,137

(22) Filed: Sep. 13, 2012

(51) Int. Cl. A01G 9/02

(52) U.S. Cl. 47/66.6

(57) ABSTRACT

A plant growth facilitating apparatus, for receiving and growing a plant, includes an accommodating body and a light emitting unit. The accommodating body defines an accommodating space for receiving the plant. The light emitting unit has a first LED set for emitting a red light in increasing the growth speed of the plant and a second LED set for emitting a blue light in promoting the photosynthesis of the plant. The wavelength range of the red light is 620-760 nanometer, and the wavelength range of the blue light is 360-480 nanometer. The light emitting unit is used for emitting light toward the accommodating space of the accommodating body, and the longest path of the light from the light emitting unit to the accommodating body is smaller than 1 meter.

### BACKGROUND OF THE INVENTION

1. Field of the Invention

The instant disclosure relates to a plant growth facilitating apparatus; more particularly, to a plant growth facilitating apparatus capable of accommodating a plant therein.

2. Description of Related Art

For the conventional accommodating structure having a box and a cover covered on the box is designed for storage and collation. Thus, the box having some partitions for dividing the space defined by the accommodating structure into a plurality of rooms. The rooms are used for receiving and classifying varied things.

However, the conventional accommodating structure is designed according to storage and collation, so that the conventional accommodating structure cannot be applied to other functions, causing the market competitiveness of the accommodating structure to become lower.

To achieve the abovementioned improvement, the inventors strive via industrial experience and academic research to present the instant disclosure, which can provide additional improvement as mentioned above.

### SUMMARY OF THE INVENTION

According to an embodiment of the instant disclosure, an plant growth facilitating apparatus is used for receiving and growing a plant and is provided for user to appreciate the plant.

The plant growth facilitating apparatus, for receiving and growing a plant, has an accommodating body and a light emitting unit. The accommodating body defines an accommodating space for receiving the plant. The light emitting unit has a first LED set for emitting a red light in increasing the growth speed of the plant and a second LED set for emitting a blue light in promoting the photosynthesis of the plant. The wavelength range of the red light is 620-760 nanometer, and the wavelength range of the blue light is 360-480 nanometer. The light emitting unit is used for emitting light toward the accommodating space of the accommodating body, and the longest path of the light from the light emitting unit to the accommodating body is smaller than 1 meter.

Preferably, the light emitting unit further includes a third LED set for emitting a green light to raise the sweet level and the crisp level of the plant, and the wavelength range of the green light is 480-530 nanometer.

Preferably, the plant growth facilitating apparatus further comprises a power unit having at least one of a conventional plug, a USB plug, and a battery trough, wherein the power unit electrically connects to the light emitting unit.

Preferably, the plant growth facilitating apparatus further comprises a table lamp having a white LED set, wherein the table lamp electrically connects to the power unit and is used for emitting a white light toward a surrounding space around the accommodating body.

Preferably, the table lamp is disposed on the light emitting unit, and the light emitting unit is selectively disposed between a first position and a second position, when the light emitting unit is at the first position, the light emitting unit is emitting light toward the accommodating space of the accommodating body, and when the light emitting unit is at the second position, the table lamp is emitting the white light toward the surrounding space around the accommodating body.

Preferably, the plant growth facilitating apparatus further comprises a power supply unit having at least one of a conventional socket and a USB socket, wherein the power supply unit electrically connects to the power unit.

Preferably, the plant growth facilitating apparatus further comprises a circuit unit electrically connected to the light emitting unit, the power unit, and the power supply unit, wherein the circuit unit has at least one memory used for storing data or providing to be read data therefrom.

Preferably, the accommodating body has a seat and at least one supporting frame connected to the seat, the seat defines the accommodating space for receiving the plant, the light emitting unit is fixed on the supporting frame, and the shortest path of the light from the light emitting unit to the seat is greater than the height of the plant.

Preferably, the accommodating body has at least one water trough for receiving water, the plant growth facilitating apparatus further has an atomization unit disposed inside the water trough and partially immersed in the water held by the water trough, and the atomization unit is used for atomizing the water of the water trough to irrigate the plant.

Preferably, the atomization unit has at least one ultrasonic atomizer immersed in the water held by the water trough and proximate to the water surface.

Preferably, the water trough is disposed around the plant, and the water depth held by the water trough is less than the height of the plant.

Base on the above, the plant growth facilitating apparatus of the instant disclosure, which is used for receiving and growing the plant, is provided for user to appreciate the plant and to carry conveniently.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is a functional block view of an plant growth facilitating apparatus of the first embodiment of the instant disclosure.

FIG. 2 is a perspective view of the plant growth facilitating apparatus of the first embodiment of the instant disclosure.

FIG. 3 is an electrical connection view of the plant growth facilitating apparatus of the first embodiment of the instant disclosure.

FIG. 4 is a perspective view of the plant growth facilitating apparatus of another type of the first embodiment of the instant disclosure.

FIG. 4A is a perspective view of the plant growth facilitating apparatus of yet another type of the first embodiment of the instant disclosure.

FIG. 5 is a perspective view of the plant growth facilitating apparatus of further still another type of the first embodiment of the instant disclosure.

FIG. 6 is a perspective view of a plant growth facilitating apparatus of the second embodiment of the instant disclosure.

FIG. 7 is an electrical connection view of the plant growth facilitating apparatus of the second embodiment of the instant disclosure.

FIG. 8 is a perspective view of the plant growth facilitating apparatus of another type of the second embodiment of the instant disclosure at the first position.

FIG. 9 is a perspective view of the plant growth facilitating apparatus of another type of the second embodiment of the instant disclosure at the second position.

FIG. 10 is a perspective view of an plant growth facilitating apparatus of the third embodiment of the instant disclosure.

FIG. 11 is an electrical connection view of the plant growth facilitating apparatus of the third embodiment of the instant disclosure.

FIG. 12 is a side view of the plant growth facilitating apparatus in FIG. 10.

FIG. 13 is a perspective view of the plant growth facilitating apparatus of another type of the third embodiment of the instant disclosure.

FIG. 14 is a perspective view of the plant growth facilitating apparatus in FIG. 13 taken from another angle.

FIG. 15 is a functional block view of an plant growth facilitating apparatus of the fourth embodiment of the instant disclosure.

### DETAILED DESCRIPTION OF THE PREFERRED EMBODIMENTS

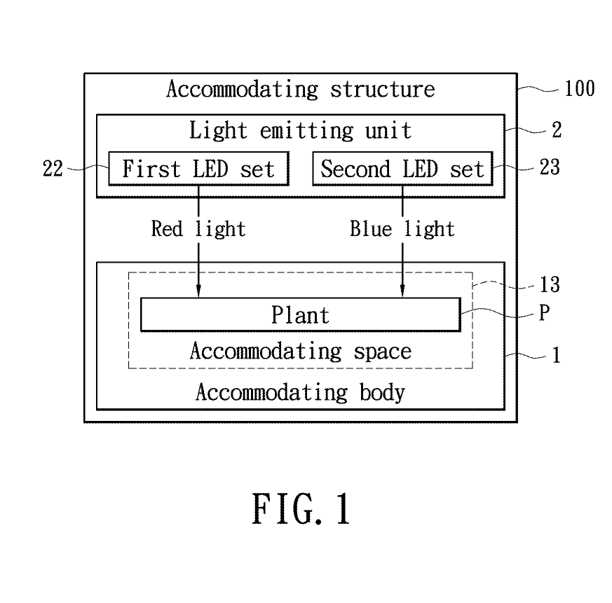

Please refer to FIG. 1, which shows an plant growth facilitating apparatus 100 for receiving and growing a plant P (e.g., pot plant). The instant disclosure takes the following embodiments for example, but not limited thereto.

### First Embodiment

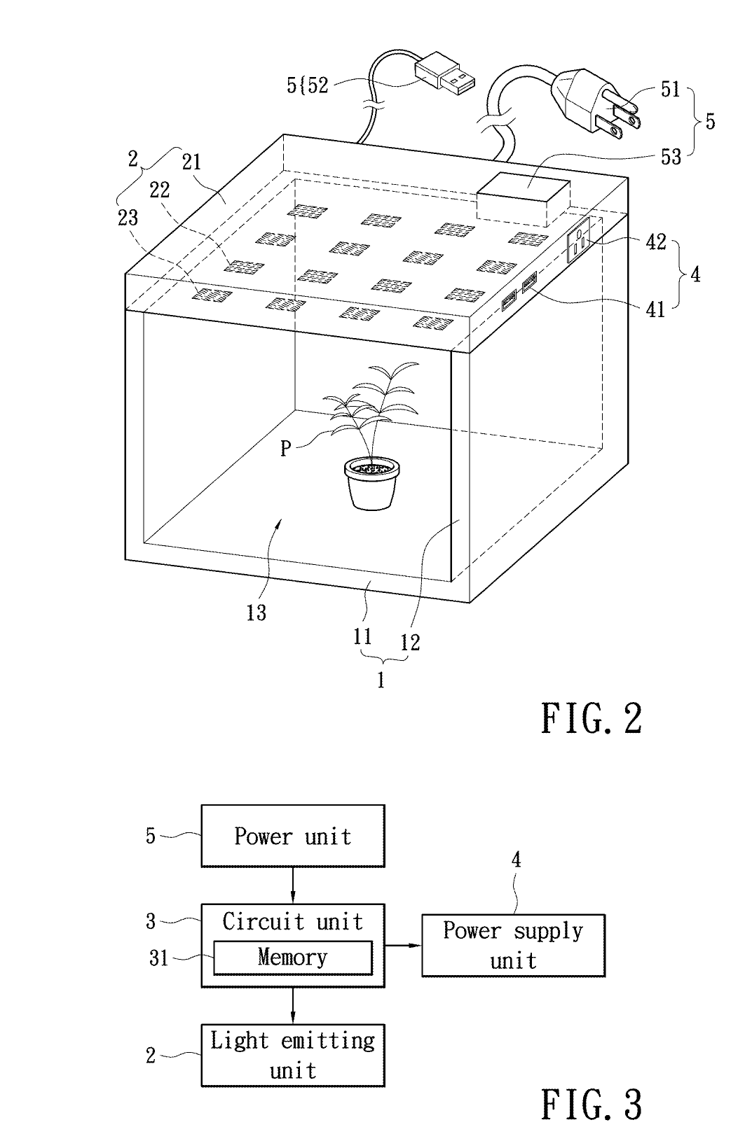

Please refer to FIGS. 1˜5, which show the plant growth facilitating apparatus 100 for a first embodiment of the instant disclosure. FIG. 1 is the functional block view of this embodiment, FIGS. 2, 4, and 5 are the perspective views of this embodiment, and FIG. 3 is the electrical connection view of this embodiment.

As shown in FIGS. 1˜3, the plant growth facilitating apparatus 100 includes an accommodating body 1, a light emitting unit 2, a circuit unit 3, a power supply unit 4, and a power unit 5.

The accommodating body 1 has a seat 11 and a supporting frame 12 connected to the seat 11. An accommodating space 13, defined by the seat 11 and the supporting frame 12, is used for receiving a plant P, and the plant P is disposed on the seat 11.

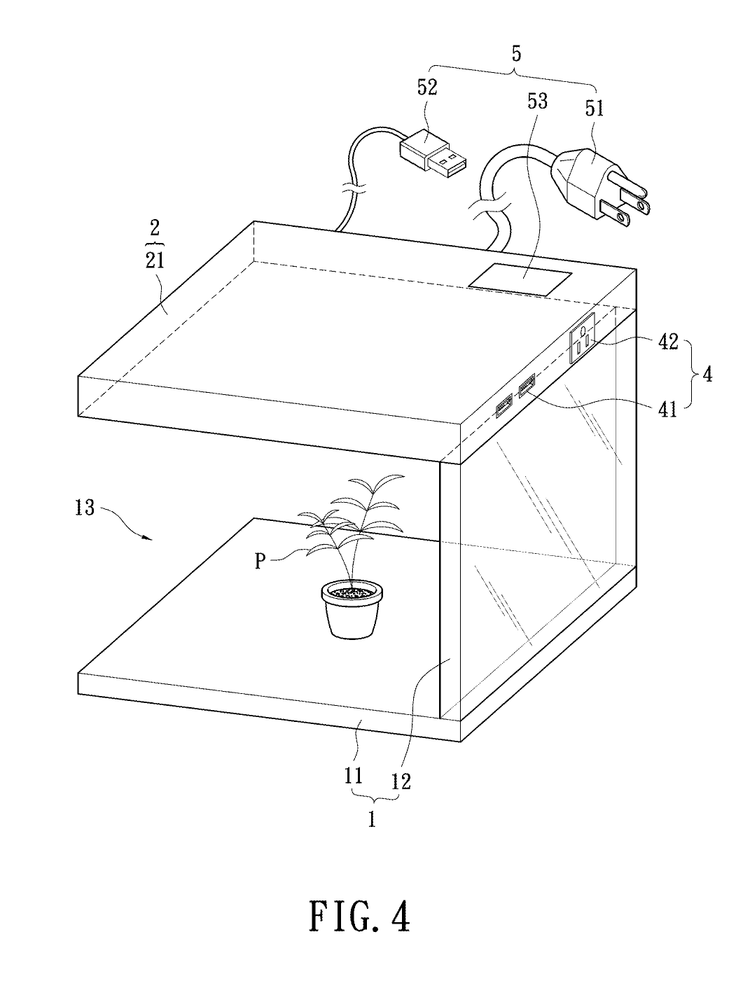

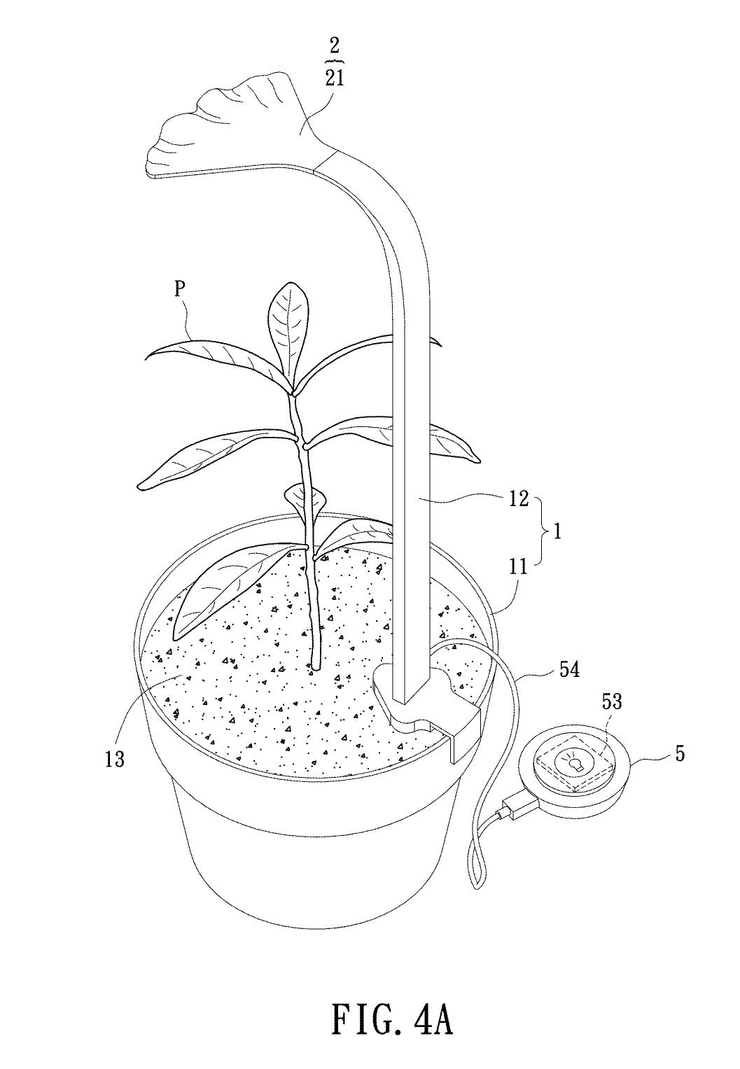

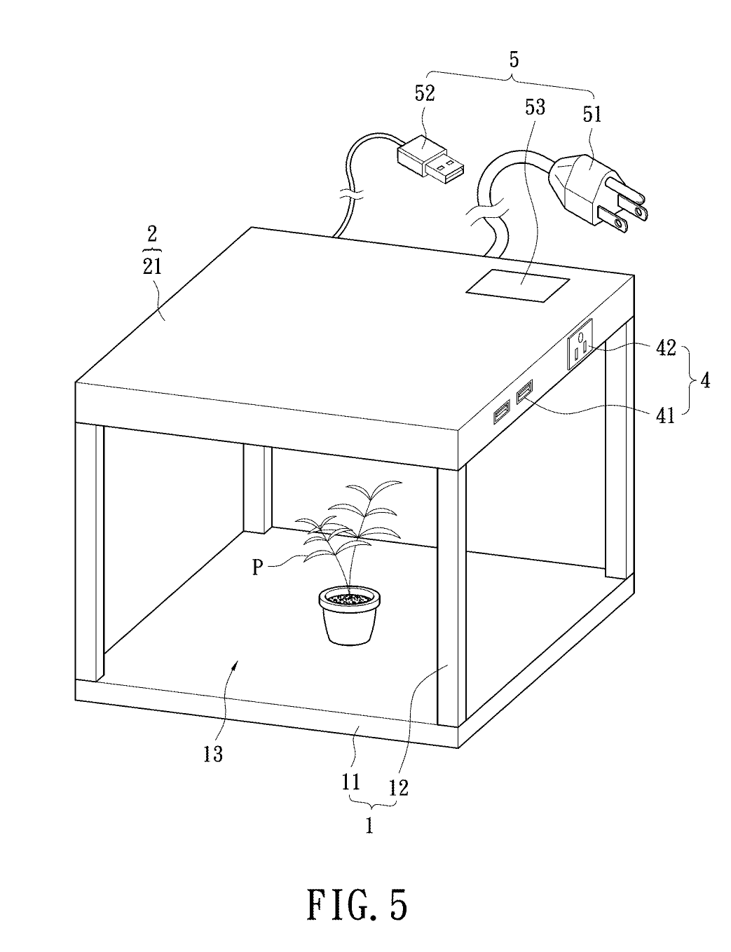

The section of the supporting frame 12, parallel to the seat 11, has a U-shape. The bottom portion of the supporting frame 12 is connected to the outer portion of the seat 11. The top portion of the supporting frame 12 is connected to the light emitting unit 2 for providing illumination. Moreover, the supporting frame 12 is provided a viewable path for user to appreciate the plant P disposed inside the accommodating space 13. The type of the supporting frame 12 takes FIG. 3 for example, but not limited thereto. In other words, the supporting frame 12 can be designed as FIG. 4, FIG. 4A, or FIG. 5 shown.

The light emitting unit 2 connected to the supporting frame 12 is used for emitting light toward the accommodating space 13 of the accommodating body 1. The connection manner between the light emitting unit 2 and the supporting frame 12 can be wedged, screwed, buckled, bonded, molded or the other suitable manner.

Moreover, the longest path of the light from the light emitting unit 2 to the accommodating body 1 is smaller than 1 meter, that is to say, the longest straight distance of the inner surface of the accommodating body 1 in this embodiment is smaller than 1 meter. The shortest path of the light from the light emitting unit 2 to the seat 11 is greater than the height of the plant P. In use, the plant growth facilitating apparatus 1 is not limited to the above conditions.

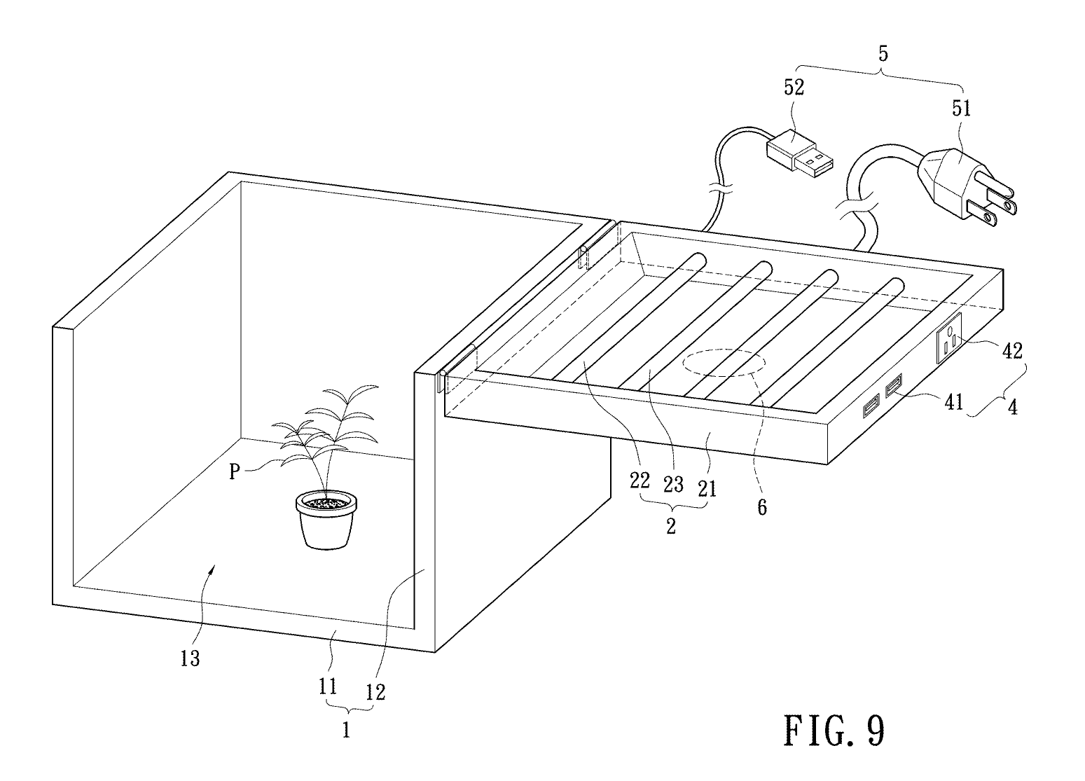

Specifically, the light emitting unit 2 has a casing 21, a first LED set 22, and a second LED set 23. The casing 21 is disposed on the supporting frame 12. The first LED set 22 and the second LED set 23 each has a plurality of LEDs (not shown) staggered disposed on the casing 21. Besides, the first LED set 22 and the second LED set 23 can be formed with lamp type and are staggered disposed on the casing 21 (as shown in FIG. 9).

The first LED set 22 is used for emitting a red light in increasing the growth speed of the plant P. The second LED set 23 is used for emitting a blue light in promoting the photosynthesis of the plant P. Moreover, the wavelength range of the red light emitting from the first LED set 22 is 620-760 nanometer. The wavelength range of the blue light emitting from the second LED set 23 is 360-480 nanometer.

The proportion of the red light emitting from the first LED set 22 to the blue light emitting from the second LED set 23 can be adjusted according to the status of the plant P.

For example, the first LED set 22 is more important than the second LED set 23 before the plant P germinating, so that the light emitting unit 2 is adjusted to provide the red light to the plant P, thereby promoting the nutrition of the plant P to become the chlorophyll. The light emitting unit 2 is adjusted to provide a specific proportion of the red light to the blue light after the plant P germinating, thereby promoting the photosynthesis of the plant P.

Furthermore, the proportion of the red light emitting from the first LED set 22 to the blue light emitting from the second LED set 23 can be adjusted according to the type of the plant P (e.g., full-sunshine or halfway-sunshine).

For example, the proportion of the red light emitting from the first LED set 22 to the blue light emitting from the second LED set 23 can be adjusted to 3:1 for the halfway-sunshine plant, but not limited thereto.

The circuit unit 3 is disposed in the casing 21 and electrically connected to the light emitting unit 2, the power supply unit 4, and the power unit 5. Thus, the circuit unit 3 can be used for transferring the electrical power getting from the power unit 5 to the first LED set 22, the second LED set 23, and the power supply unit 4.

The circuit unit 3 has a circuit board, an AC-AC convertor, a DC-DC convertor, a DC-AC convertor, and the other relative electronic component, thereby adjusting the input electrical power to output a suitable electrical power type. Moreover, the circuit unit 3 has at least one memory 31. The memory 31 is used for storing data or providing to be read data therefrom.

The power supply unit 4 has a USB socket 41 and a conventional socket 42. The USB socket 41 and the conventional socket 42 are disposed on the casing 21 for supplying energy to a device inserted thereto. Moreover, the USB socket 41 and the conventional socket 42 are disposed on the casing 21 in this embodiment, but not limited thereto.

The power unit 5 has a conventional plug 51, a USB plug 52, and a battery trough 53. The conventional plug 51, the USB plug 52, and the battery trough 53 are disposed on the casing 21 and electrically connected to the circuit unit 3.

The conventional plug 51 is used for inserting into a conventional socket (e.g., wall socket), thereby getting AC electrical power. The USB plug 52 is used for inserting into a USB socket (e.g., USB socket of computer), thereby getting DC electrical power. The battery trough 53 is used for receiving a battery (or rechargeable battery), thereby getting DC electrical power.

Thus, the power unit 5 can get an electrical power by one of the conventional plug 51, the USB plug 52, and the battery trough 53, so that the power unit 5 can transfer the electrical power to the first LED set 22, the second LED set 23, the USB socket 41, and the conventional socket 42 via the circuit unit 3.

Moreover, in use, the power unit 5 can only has one or two of the conventional plug 51, the USB plug 52, and the battery trough 53, and the electronic components of the circuit unit 3 can be changed by design demand.

Besides, comparing to the plant growth facilitating apparatus 100 in FIGS. 2, 4, and 5, the plant growth facilitating apparatus 100 in FIG. 4A has some difference as follows.

As shown in FIG. 4A, the seat 11 defines the accommodating space 13 for receiving the plant P. One end portion of the supporting frame 12 is fixed on the casing 21, and the opposite end portion is connected to the seat 11.

Moreover, the light emitting unit 2 electrically connects to the power unit 5 via a communicating cable 54. The light emitting unit 2 can get electrical power from the power unit 5 when turning on the power unit 5. The power unit 5 has a battery trough 53 for receiving a battery (or rechargeable battery), so that user can get DC electrical power from the power unit 5.

### Second Embodiment

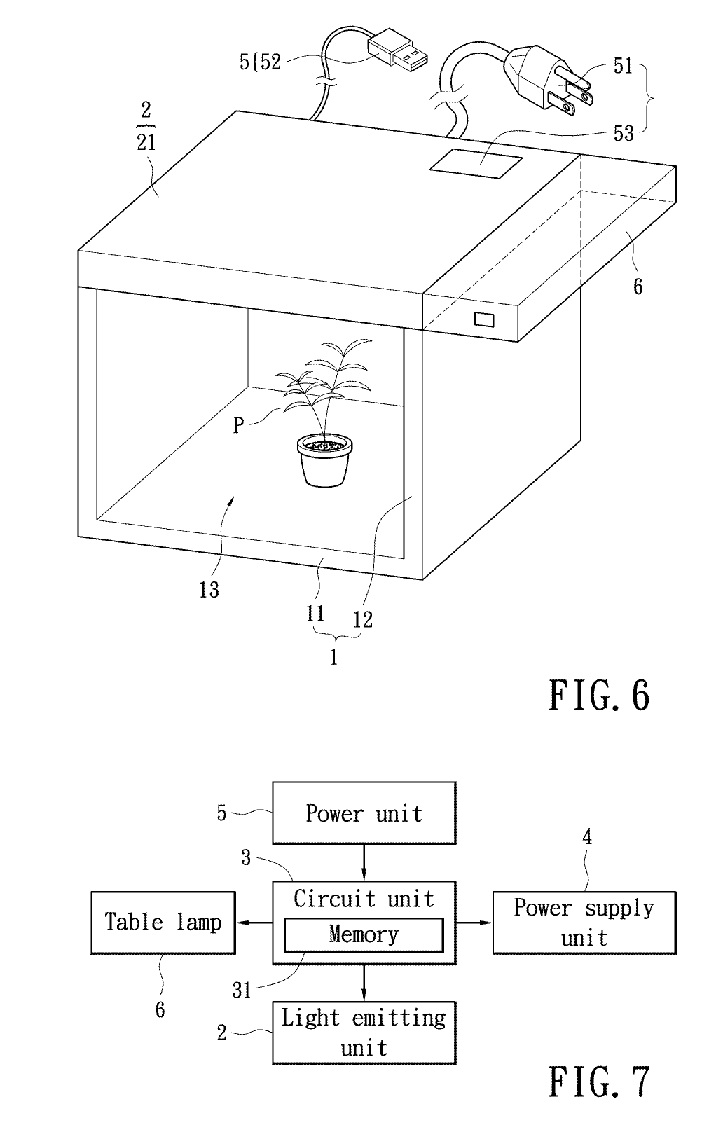

Please refer to FIGS. 6˜9, which show the plant growth facilitating apparatus 100 for a second embodiment of the instant disclosure. FIGS. 6, 8, and 9 are the perspective views of this embodiment, and FIG. 7 is the electrical connection view of this embodiment.

Specifically, this embodiment is similar to the first embodiment. The difference between the first and the second embodiments is that the second embodiment further has a table lamp 6 having a white LED set.

As shown in FIGS. 6 and 7, the table lamp 6 is disposed on one side of the casing 21 and is electrically connected to the power unit 5 via the circuit unit 3. The table lamp 6 can be turned on by user, for emitting a white light toward a surrounding space around the accommodating body 1, thereby providing illumination.

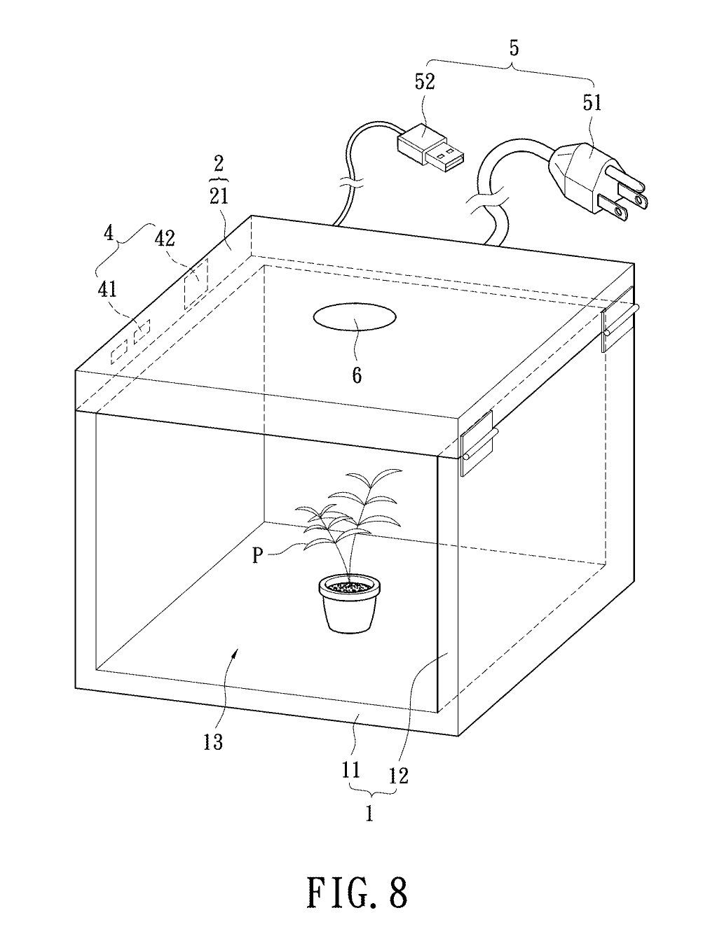

As shown in FIGS. 8 and 9, the table lamp 6 is disposed on one side of the casing 21, and the first LED set 22 and the second LED set 23 are disposed on opposite sides of the casing 21. The lateral side of the casing 21 is pivoted on the top portion of the supporting frame 12, so that the casing 21 is selectively disposed between a first position (as shown in FIG. 8) and a second position (as shown in FIG. 9).

More detail, the light emitting unit 2 is selectively disposed between the first position and the second position. When the light emitting unit 2 is at the first position, the first LED set 22 and the second LED set 23 are emitting light toward the accommodating space 13 of the accommodating body 1. When the light emitting unit 2 is at the second position, the table lamp 6 is emitting the white light toward the surrounding space around the accommodating body 1.

When the light emitting unit 2 is adjusted between the first position and the second position, the first and the second LED sets 22, 23 and the table lamp 6 can be turned on or off automatically by the electronic component of the circuit unit 3. In other words, when the light emitting unit 2 is at the first position, the first LED set 22 and the second LED set 23 are turned on for emitting light by the circuit unit 3, and the table lamp 6 is turned off When the light emitting unit 2 is at the second position, the table lamp 6 is turned on for emitting light by the circuit unit 3, and the first LED set 22 and the second LED set 23 are turned off Besides, the first and the second LED sets 22, 23 and the table lamp 6 can be turned on or off by hand-operated, not limited to automatically.

### Third Embodiment

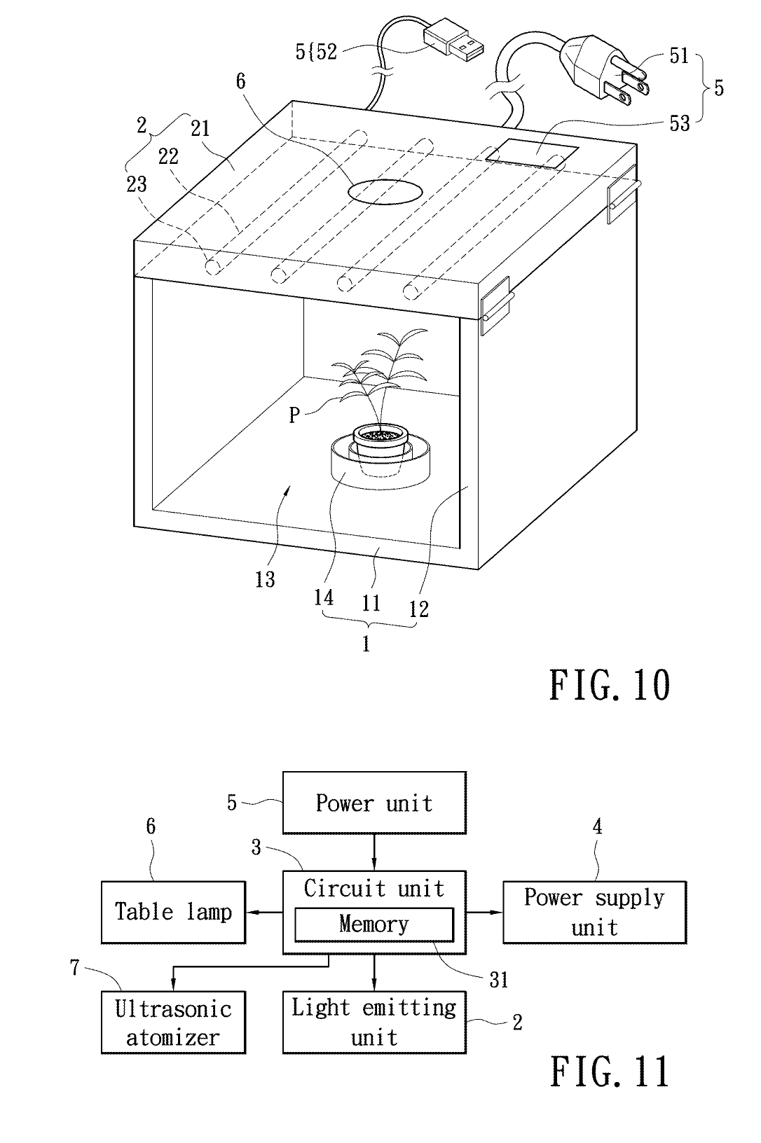

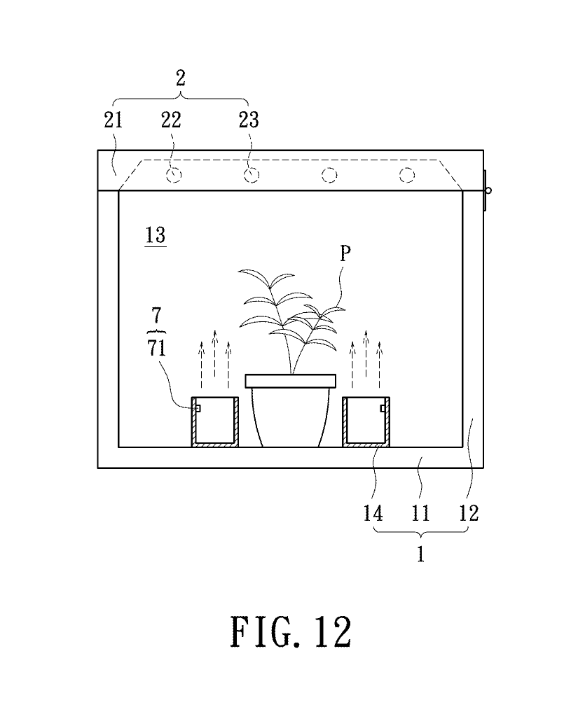

Please refer to FIGS. 10˜14, which show the plant growth facilitating apparatus 100 for a third embodiment of the instant disclosure. FIGS. 10, 13, and 14 are the perspective views of this embodiment, FIG. 11 is the electrical connection view of this embodiment, and FIG. 12 is the side view of this embodiment.

Specifically, this embodiment is similar to the first embodiment. The difference between the first and the third embodiments is that the third embodiment further has an atomization unit 7.

As shown in FIGS. 10˜12, the accommodating body 1 has a water trough 14 for receiving water. The water trough 14 is disposed around the plant P, and the water depth held by the water trough 14 is less than the height of the plant P.

The atomization unit 7 has at least one ultrasonic atomizer 71. The ultrasonic atomizer 71 is used for atomizing water into mist by an ultrasonic wave generated from the PZT Actuated Micro-Droplet Spray.

The atomization unit 7 in this embodiment is electrically connected to the circuit unit 3 for getting electrical power, but not limited thereto. For example, the atomization unit 7 can be installed a power storage (e.g. battery) for operating the atomization unit 7.

The ultrasonic atomizer 71 is immersed in the water held by the water trough 14 and proximate to the water surface. Thus, the ultrasonic atomizer 71 of the atomization unit 7 is used for atomizing the water of the water trough 14 to irrigate the plant P.

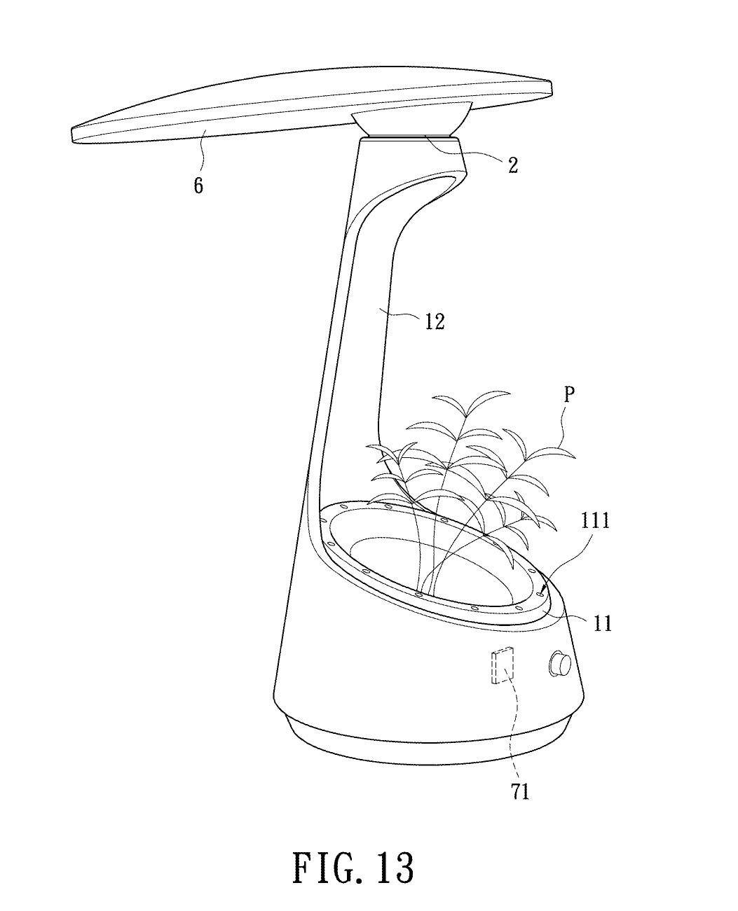

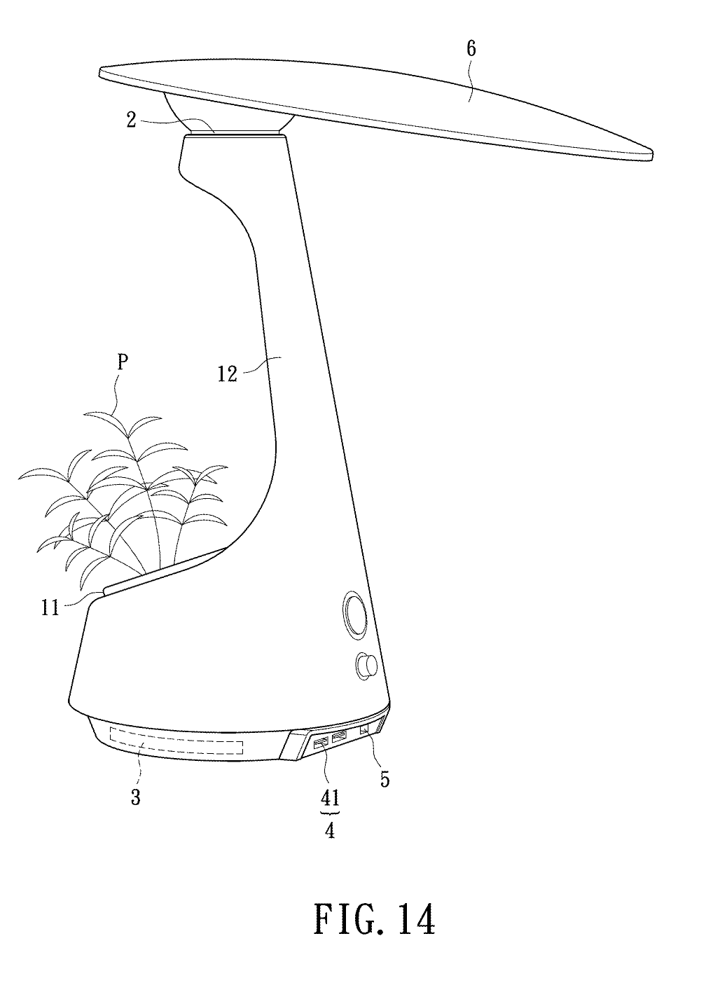

As shown in FIGS. 13 and 14, the water trough 14 and the seat 11 can be formed integrated in one piece. The inner surface of the seat 11 has trough-shaped for receiving the plant P. The seat 11 is hollow for receiving water and the ultrasonic atomizer 71. The top surface of the seat 11 has a plurality of openings 111 formed thereof Thus, when the ultrasonic atomizer 71 atomizing the water, the mist passes through the openings 111 to irrigate the plant P.

Moreover, the circuit unit 3, the power supply unit 4, and the power unit 5 can be integrated to the bottom portion of the seat 11, causing the plant growth facilitating apparatus 1 more beautiful.

### Fourth Embodiment

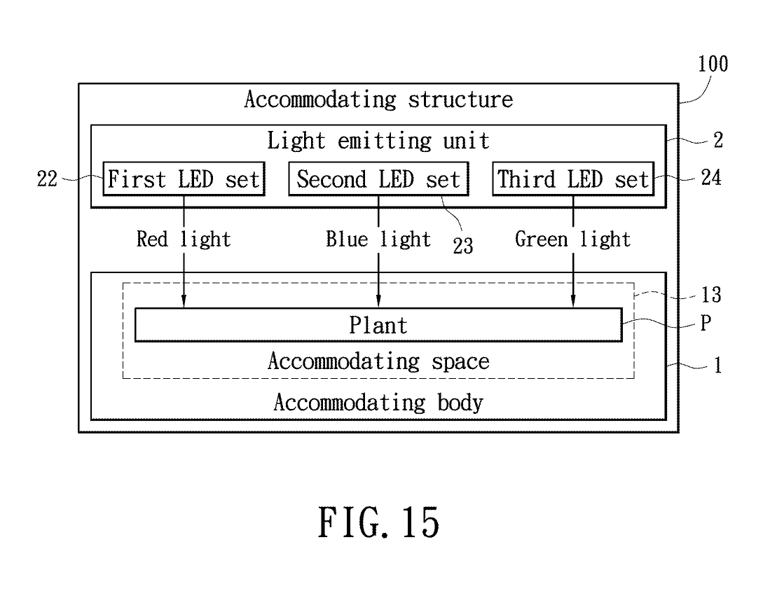

Please refer to FIG. 15, which shows the plant growth facilitating apparatus 100 for a fourth embodiment of the instant disclosure. This embodiment is similar to the above embodiments. The difference between this embodiment and the above embodiments is as follows.

The light emitting unit 2 further has a third LED set 24 disposed on the casing 21. The third LED set 24 is used for emitting a green light to raise the sweet level and the crisp level of the plant P, and the wavelength range of the green light is 480-530 nanometer.

The third LED set 24 is electrically connected to the circuit unit 3 for getting electrical power from the power unit 5 via the circuit unit 3. Moreover, the third LED set 24 can be disposed adjacent to the first and the second LED sets 22, 23, but not limited thereto.

Based on the above, the plant growth facilitating apparatus of the instant disclosure is used for growing and appreciating the plant and is conveniently for carrying. Moreover, the plant growth facilitating apparatus of the instant disclosure has a plurality of functions, such as socket and table lamp.

In addition, the plant growth facilitating apparatus of the instant disclosure has the atomization unit and the water trough for supplying water to the plant. When water atomized to mist by the atomization unit, the mist makes the plant growth facilitating apparatus to present dreamily.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A plant growth facilitating apparatus, for receiving and growing a plant , comprising:
an accommodating body defining an accommodating space for receiving the plant; and
a light emitting unit having a first LED set for emitting a red light for increasing the growth speed of the plant and a second LED set for emitting a blue light for promoting the photosynthesis of the plant,
wherein the wavelength range of the red light is 620-760 nanometer, the wavelength range of the blue light is 360-480 nanometer,
wherein the light emitting unit is configured to emit light toward the accommodating space of the accommodating body,
wherein the longest path of the light from the light emitting unit to the accommodating body is no more than 1 meter.

2. The plant growth facilitating apparatus as claimed in claim 1, wherein the light emitting unit further includes a third LED set for emitting a green light to raise the sweet level and the crisp level of the plant, and the wavelength range of the green light is 480-530 nanometer.

3. The plant growth facilitating apparatus as claimed in claim 1, further comprising a power unit having at least one of a conventional plug, a USB plug, and a battery trough, wherein the power unit electrically connects to the light emitting unit.

4. The plant growth facilitating apparatus as claimed in claim 3, further comprising a table lamp having a white LED set, wherein the table lamp electrically connects to the power unit and is used for emitting a white light toward a surrounding space around the accommodating body.

5. The plant growth facilitating apparatus as claimed in claim 4, wherein the table lamp is disposed on the light emitting unit, and the light emitting unit is selectively disposed between a first position and a second position, when the light emitting unit is at the first position, the light emitting unit is emitting light toward the accommodating space of the accommodating body, and when the light emitting unit is at the second position, the table lamp is emitting the white light toward the surrounding space around the accommodating body.

6. The plant growth facilitating apparatus as claimed in claim 3, further comprising a power supply unit having at least one of a conventional socket and a USB socket, wherein the power supply unit electrically connects to the power unit.

7. The plant growth facilitating apparatus as claimed in claim 6, further comprising a circuit unit electrically connected to the light emitting unit, the power unit, and the power supply unit, wherein the circuit unit has at least one memory used for storing data or providing to be read data therefrom.

8. The plant growth facilitating apparatus as claimed in claim 1, wherein the accommodating body has a seat and at least one supporting frame connected to the seat, the seat defines the accommodating space for receiving the plant, the light emitting unit is fixed on the supporting frame, and the shortest path of the light from the light emitting unit to the seat is greater than the height of the plant.

9. The plant growth facilitating apparatus as claimed in claim 1, wherein the accommodating body has at least one water trough for receiving water, the plant growth facilitating apparatus further has an atomization unit disposed inside the water trough and partially immersed in the water held by the water trough, and the atomization unit is used for atomizing the water of the water trough to irrigate the plant.

10. The plant growth facilitating apparatus as claimed in claim 9, wherein the atomization unit has at least one ultrasonic atomizer immersed in the water held by the water trough and proximate to the water surface.

11. The plant growth facilitating apparatus as claimed in claim 10, wherein the water trough is disposed around the plant, and the water depth held by the water trough is less than the height of the plant.
